(19) United States
(12) Patent Application Publication
(10) Pub. No.: US 2013/0232580 A1
(43) Pub. Date: Sep. 5, 2013

(54) SYSTEM AND METHOD FOR ADMINISTERING REMOTE CONTENT

(71) Applicant: ISAAC S. DANIEL, Miami, FL (US)

(72) Inventor: ISAAC S. DANIEL, Miami, FL (US)

(21) Appl. No.: 12/704,332

(22) Filed: Feb. 11, 2010

Related U.S. Application Data
(60) Provisional application No. 61/300,254, filed on Feb. 1, 2010.
(60) Provisional application No. 61/290,835, filed on Dec. 29, 2009.

(51) Int. Cl. G06F 21/00

(52) U.S. Cl. 726/28

(57) ABSTRACT

A system comprising: a processor; a sensor electronically connected to the processor; and computer executable instructions readable by the processor and operative to use the sensor to determine an identity of a person capable of perceiving a content broadcasted through a broadcasting device. A method comprising using at processor to perform any or all of the following: using a sensor to determine an identity of a person capable of perceiving sensory perceivable content; and controlling the content based on the identity of the person. A computer readable medium having computer executable instructions for performing a method comprising using a sensor to determine an identity of a person that is capable of perceiving sensory perceivable content; and controlling the content based on the identity of the a person.

### PRIORITY CLAIM

This patent application is a continuation-in-part patent application and claims priority, under 35 U.S.C. §119(e), to U.S. Provisional Patent Application Ser. No. 61/300,254, titled “System and Method for Broadcasting Media, filed Feb. 1, 2010; U.S. Non-Provisional patent application Ser. No. 12/702,762, titled “System and Method for Broadcasting Media,” filed Feb. 9, 2010; U.S. patent application Ser. No. 12/685,417, titled “System and Method for Broadcasting Media,” filed Jan. 11, 2010; and U.S. Provisional Patent Application Ser. No. 61/290,835, titled “Electronic Device and System and Method for Broadcasting Media,” filed Dec. 29, 2009, all of which are hereby incorporated by reference as if fully stated herein.

### FIELD

The present disclosure relates generally to electronic systems, and more particularly, to systems, methods, and various other disclosures related to remote, content, and more particularly, to remote education and examination, such as online education and examination.

### BACKGROUND

It is common practice for schools, including colleges and universities, to administer remote education, such as online education. Online education may comprise of various components, such as online classes, online tutoring sessions, online homework assignments, and online examinations.

Traditionally, schools have had no way to track who was actually taking part in the online classes, nor who was taking online examinations. The lack of authentication available to schools has opened up the opportunity for people to cheat on online exams and to skip out on online classes without the school ever learning of the fact. This “loophole” in online examination has caused many people to question the credibility and effectiveness of remote education, which in turn has harmed the reputation of the schools that use remote education as a part of their curriculum.

### SUMMARY

The various systems, methods, and embodiments described herein result from the realization that remote education may be made more secure and credible by providing a system and method whereby a proctor, such as a school, is able to verify and authenticate the identity of a person participating in remote education, such as an online class and/or an online examination.

Accordingly, the various embodiments and disclosures described herein solve the limitations of the prior art in a new and novel manner.

### BRIEF DESCRIPTION OF THE DRAWINGS

FIGS. 1A and 1B show a system in accordance with various embodiments;

FIGS. 2A and 2B show a system in accordance with various embodiments;

FIG. 3 shows a flow diagram representing a method in accordance with one embodiment;

FIG. 4 shows a system in accordance with one embodiment;

FIG. 5 shows a flow diagram representing a method in accordance with one embodiment; and

FIG. 6 shows an article in accordance with one embodiment.

### DETAILED DESCRIPTION OF PREFERRED EMBODIMENTS

### System Level Overview

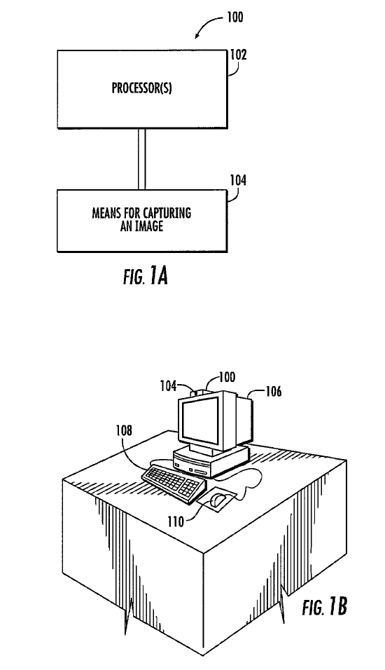

FIGS. 1A and 1B show a system 100 in accordance with some embodiments. In one embodiment, as shown in FIG. 1A, system 100 comprises at least one processor 102, at least one means for capturing an image 104, wherein the at least one means for capturing an image 104 is electronically connected to the at least one processor, and computer executable instructions (not shown) readable by the at least one processor and operative to analyze at least one image captured by the at least one means for capturing an image, determine the identity of at least one person that is in the at least one image, and control a content displayed on at least one display device connected to the system based on the identity of the at least one person.

In a further embodiment, system 100 further comprises at least one means for electronically connecting a display device (shown as 106) to system 100, wherein the means for electronically connecting a display device is electronically connected to at least one processor 102.

In some embodiments, the at least one processor 102 may be any kind of processor, including, but not limited to, a single core processor, a multi core processor, a video processor, and the like.

The means for capturing an image 104 may be any such means, such as, but not limited to, a camera, an infrared camera, a thermal imaging camera, a video sensor, a digital camera, and the like. The means for capturing an image 104 may include a flash, which may be used to illuminate the subjects in the image. In a preferred embodiments, the means for capturing an image 104 may include a field of view that encompasses the same field of view as, or larger than, the display device 106 that may be connected to system 100. In a further embodiment, means for capturing an image 104 may include a one hundred and eighty degree field of view, such as by including an ultra wide angle lens.

In some embodiments, the at least one means for electronically connecting a display device to the system 106 may be any kind of means, such as a video connector, a coaxial cable, an HDMI cable, an s-video component connector, a Wi-Fi video transceiver, a Bluetooth video transceiver, an internal video cable socket, a DVI connector, and the like. The means for electronically connecting a display device to the system may include a cable, or may not include a cable. The display device 106 may be any kind of display device, such as, but not limited to, a television, a computer monitor, a projector, or any other kind of screen and/or display device.

The computer executable instructions may be loaded directly on the processor, or may be stored in a storage means, such as, but not limited to, computer readable media, such as, but not limited to, a hard drive, a solid state drive, a flash memory, random access memory, CD-ROM, CD-R, CD-RW, DVD-ROM, DVD-R, DVD-RW, and the like. The computer executable instructions may be any type of computer executable instructions, which may be in the form of a computer program, the program being composed in any suitable programming language or source code, such as C++, C, JAVA, JavaScript, HTML, XML, and other programming languages.

In one embodiment, the computer executable instructions may include image recognition software and/or firmware, which may be used to analyze the images captured and to determine the number of persons present in the image, and consequently in the image capturing means field of view. Such image recognition software may include facial recognition software, eye tracking software, or may simply include general object recognition software.

The terms “object recognition software,” “facial recognition software,” and “image recognition software,” as used throughout the present disclosure, may refer to the various embodiments of object recognition software known in the art, including, but not limited to, those embodiments described in the following publications: Reliable Face Recognition Methods: System Design, Implementation, and Evaluation, by Harry Wechsler, Copyright 2007, Published by Springer, ISBN-13: 978-0-387-22372-8; Biometric Technologies and Verification Systems, by John Vacca, Copyright 2007, Elsevier, Inc., Published by Butterworth-Heinemann, ISBN-13: 978-0-7506-7967-1; and Image Analysis and Recognition, edited by Aurelio Campilho and Mohamed Kamel, Copyright 2008, Published by Springer, ISBN-13: 978-3-540-69811-1, all of which are herein incorporated by reference.

In some embodiments, the computer executable instructions may be further operative to compare the identity of the at least one person to the identity of a person that is authorized to view the content displayed on the at least one display device 106. In some embodiments, the identity of a person that is authorized to view the content may be contained in a license to view the content. In other embodiments, the identity of the person that is authorized to the view the content may be received from a remote station, such as a server, an online school, a television or movie service provider, and the like, any of which may be in communication with system 100. In yet other embodiments, the identity of the person authorized to view the content may be contained on a piece of media hardware, such as a DVD, CD, and the like.

In a further embodiment, the computer executable instructions may be operative to control the content displayed on the at least one display device 106 if the identity of the person does not correspond to the identity of the person authorized to view the content displayed on the at least one display device 106. In some embodiments, controlling the content displayed on the at least one display device 106 includes, but is not limited to, ceasing to play the content, pausing the content, playing the content, or continuing to play the content. In some embodiments, for example, if at the outset of the content's display, the identity of the at least person capable of viewing the content or viewing the content does not correspond to the identity of the person authorized to view the content, the content may not even begin playing. In further embodiments, if the identity of the at least person capable of viewing the content or viewing the content corresponds to the identity of the person authorized to view the content, but at a later time does not correspond to the identity of the person authorized to view the content, the computer executable instructions may pause, freeze, or cease playing the content altogether. In a further embodiment, if the identity of the at least person capable of viewing the content or viewing the content at first does not correspond to the identity of the person authorized to view the content, but then later does correspond, the computer executable instructions may begin or continue playing the content. The content may be any kind of content, such as, but not limited to, a movie, a television show, a sports broadcast, such as a sports event, news, educational content, such as, but not limited to, a class, a class, an exam, such as, but not limited to, an online class, an online exam, and the like.

In a further embodiments, system 100 comprises at least one means for communication with a local device, wherein the means for communicating with the local device is electronically connected to the at least one processor 102. In some embodiments, such means may include a Bluetooth module, a USB port, an infrared port, a network adapter, such as a Wi-Fi card, and the like. The local device may be any kind of device, such as a television, a computer, a remote control, a keyboard 108, a mouse 110, a telephone, a portable digital assistant, and the like.

In yet another embodiment, system 100 further comprises at least one means for communicating with a remote station, wherein the means for communicating is electronically connected to the at least one processor 102. In some embodiments, the means for communicating with a remote station may be any kind of means, such as, but not limited to, a wireless modem, such as a GSM modem, a wired modem, an Ethernet adapter, a Wi-Fi adapter, and the like. In some embodiments, the remote station may be a media service provider, such as, but not limited to, a television service provider, a movie provider, a sports media provider, an internet provider, a television station, a server computer, and the like. In such embodiments, the computer executable instructions may be further operative to use the at least one means for communicating with a remote station to receive information from the remote station. The information may include media content, such as television shows, sports broadcasts, movies, educational content, such as, but not limited to, a class, a course, an exam, such as, but not limited to, an online course, an online exam, and the like. The information may also include how many persons are authorized to view the media content, the identity of the persons authorized to view the content, billing information, and software updates. In some embodiments, a user may use system 100 to select and/or download the media to be viewed, and may select the amount of persons and/or the identity of persons authorized to watch the media.

In one embodiment, system 100 may be positioned on or near a display device 106, such as a television or computer monitor (as shown in FIG. 1B). In other embodiments, system 100 may be positioned within, or integrated with a display device, such as a television, tablet computer, personal computer, laptop computer, and the like.

In some embodiments, system 100 may further comprise a means for receiving user input, which in some embodiments, may be any type of means, including, but not limited to: a telephone modem: a key pad, a key board 108, a remote control, a touch screen, a virtual keyboard, a mouse 110, a stylus, a microphone, a camera, a fingerprint scanner, and a retinal scanner. In a further embodiment, system 100 may include a biometric identification and/or verification means to identify the person perceiving the content, such as a fingerprint scanner, an eye scanner, and facial recognition software.

In yet a further embodiment, at least one of the at least one processor and the at least one means for capturing an image may be part of a system, wherein the system is a type of system selected from the group consisting essentially of a biometric verification system, a retinal scanning system, a face recognition system, and an eye tracker.

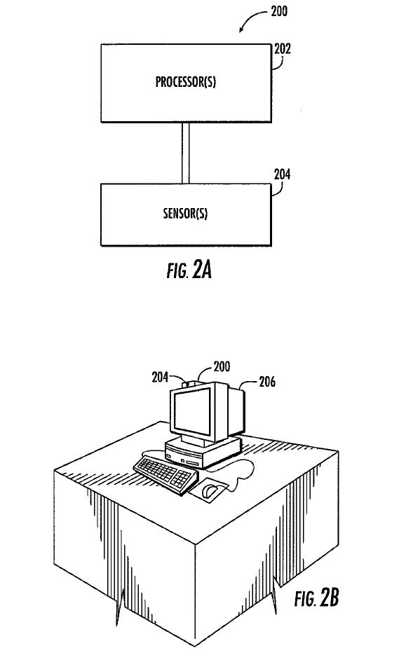

FIGS. 2A and 2B show system 200 in accordance with some embodiments. In one embodiment, as shown in FIG. 2A, system 200 comprises at least one processor 202, at least one sensor 204 electronically connected to at least one processor 202, and computer executable instructions (not shown) readable by at least one processor 202, and operative to use at least one sensor 204 to determine an identity of at least one person capable of perceiving a content broadcasted through at least one broadcasting device 208 electronically connected to system 200.

In a further embodiment, system 200 comprises at least one means for electronically connecting at least one broadcasting device (shown as 206 in FIG. 2B) to the system, wherein the at least one means for electronically connecting at least one broadcasting device 206 is electronically connected to at least one processor 202

In some embodiments, at least one processor 202 may be any kind of processor, including, but not limited to, at single core processor, a multi core processor, a video processor, and the like.

At least one sensor 204 may be any kind of sensor, including, but not limited to, a video sensor, such as a camera, a motion sensor, and the like, an audio sensor, such as a microphone, a tactile sensor, such as a vibration sensor, a chemical sensor, such as an odor sensor, and the like, an electrical sensor, such as a capacitive sensor, a resistive sensor, and the like, and a thermal sensor, such as a heat sensor and/or infrared camera, and the like. At least one sensor 204 may be positioned in the same enclosure as at least one processor 202. Alternatively, at least one sensor 204 may be positioned remotely to at least one processor, such as near a couch, or another location. In a further embodiment, at least one sensor 104 may include a one hundred and eighty degree field of sensing, such as by including an ultra wide angle lens.

In some embodiments, at least one means for electronically connecting at least one broadcasting device 206 to system 200 may include any such means, such as, but not limited to, an audio connection, such as a speaker connection, and/or a video connection, such as an HDMI, S-Video, or RCA connection, and the like. The broadcasting device 206 may be any kind of broadcasting device, such as a speaker system, headphones, a television, a computer screen (as shown in FIG. 2B), a projector, and the like.

The computer executable instructions may be loaded directly on the processor, or may be stored in a storage means, such as, but not limited to, computer readable media, such as, but not limited to, a hard drive, a solid state drive, a flash memory, random access memory, CD-ROM, CD-R, CD-RW, DVD-ROM, DVD-R, DVD-RW, and the like. The computer executable instructions may be any type of computer executable instructions, which may be in the form of a computer program, the program being composed in any suitable programming language or source code, such as C++, C, JAVA, JavaScript, HTML, XML, and other programming languages.

In one embodiment, the computer executable instructions may include object recognition software, such as image recognition software and/or firmware, which may be used to analyze the information captured by at least one sensor 204 and to determine the identity of the at least one person present in the information, and consequently in the at least one sensor's 204 field of sensing. Such object recognition software may include image recognition software, which may, in turn, include facial recognition software, eye tracking software, or may simply include general visual object recognition software. In another embodiment, the object recognition software may be audio based, being able to distinguish objects (e.g. persons) that are producing certain audio (such as breathing, talking, etc.). In yet a further embodiment, the object recognition software may use a plurality of at least one sensor 204 to determine the identity of and/or how many persons are capable of perceiving the content.

In some embodiments, the computer executable instructions may be further operative to control the content based on the identity of the at least one person determined to be capable of perceiving the content. In a further embodiment, the computer executable instructions may be operative to control the content being broadcasted if the identity of the at least one person determined to be capable of perceiving the content does not correspond to the identity of the person authorized to perceive the content. In some embodiments, controlling the content being broadcasted includes, but is not limited to, ceasing to broadcast the content, pausing the content, playing the content, or continuing to play the content. In some embodiments, for example, if at the outset of the content's display, the identity of the at least person capable of viewing the content or viewing the content does not correspond to the identity of the person authorized to view the content, the content may not even begin playing. In further embodiments, if the identity of the at least person capable of viewing the content or viewing the content corresponds to the identity of the person authorized to view the content, but at a later time does not correspond to the identity of the person authorized to view the content, the computer executable instructions may pause, freeze, or cease playing the content altogether. In a further embodiment, if the identity of the at least person capable of viewing the content or viewing the content at first does not correspond to the identity of the person authorized to view the content, but then later does correspond, the computer executable instructions may begin or continue playing the content. The content may be any kind of content, such as, but not limited to, a movie, a television show, a sports broadcast, such as a sports event, news, a radio show, an audio book, music, a scent, a smell, educational content, such as, but not limited to, a course, a class, an exam, such as, but not limited to, an online course, an online class, an online exam, and the like.

It should be noted that the terms “perceive,” “perceiving,” “view,” and “viewing,” are not meant to create the limitation that the persons must be actually perceiving content, but merely that they are capable of perceiving content, such as by being in the same room as where the content is being played.

In a further embodiments, system 200 comprises at least one means for communication with a local device, wherein the means for communicating with the local device is electronically connected to the at least one processor 202. In some embodiments, such means may include a Bluetooth module, a USB port, an infrared port, a network adapter, such as a Wi-Fi card, and the like. The local device may be any kind of device, such as a television, a keyboard 208 (as shown in FIG. 2B), a mouse 210 (as shown in FIG. 2B) a computer, a remote control, a telephone, a portable digital assistant, and the like.

In yet another embodiment, system 200 further comprises at least one means for communicating with a remote station, wherein the means for communicating is electronically connected to the at least one processor 202. In some embodiments, the means for communicating with a remote station may be any kind of means, such as, but not limited to, a wireless modem, such as a GSM modem, a wired modem, an Ethernet adapter, a Wi-Fi adapter, and the like. In some embodiments, the remote station may be a media service provider, such as, but not limited to, a television service provider, a movie provider, a sports media provider, a radio station, an internet provider, a television station, a server computer, and the like.

In some embodiments, the computer executable instructions may be further operative to use the at least one means for communicating with a remote station to transmit or receive information from the remote station. The information may include media content, such as television shows, sports broadcasts, movies, music, radio shows, smells, scents, educational content, such as, but not limited to, classes, courses, exams, material, such as, but not limited to, online courses, online exams, online classes, and the like. The information may also include how many and/or the identity of persons that are authorized to view the media content, viewer content, billing information, biometric information, and software updates. In some embodiments, a user may use system 200 to select and/or download the media to be viewed, and may select the identity and/or the amount of persons authorized to watch the media.

In yet a further embodiment, the computer executable instructions are further operative to allow at least one person to register for the content. In some embodiments, this may include allowing at least one person to register for an online course, class, or exam. Such registration may take place over the internet, over the phone, by mail, or in-person.

In one embodiment, system 200 may be positioned on or near a display device 206, such as a television or computer monitor (as shown in FIG. 2B). In other embodiments, system 200 may be positioned within, or integrated with a broadcasting device, such as a television, tablet computer, a personal computer, laptop computer, radio, smell producer, and the like.

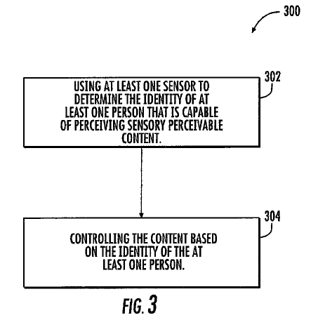

FIG. 3 shows a flow diagram representing an embodiment of method 300, wherein method 300 comprises using at least one processor to perform any or all of the following: using at least one sensor to determine the identity of at least one person that is capable of perceiving sensory perceivable content (block 302), and controlling the content based on the identity of the person (block 304).

In some embodiments, the sensor may be any kind of sensor, including, but not limited to, a visual sensor, an audio sensor, a tactile sensor, a thermal sensor, a chemical sensor, an electrical sensor, a capacitive sensor, a resistive sensor, a camera, a thermal imaging camera, a microphone, any other type of sensor described herein, and the like.

In some embodiments, the sensory perceivable content may be audio content, such as music, dialogue, and the like, and/or visual content, such as images, text, movies, television shows, sports events, educational content, such as courses, classes, exams, course materials, such as, but not limited to, online courses, online classes, online exams, online materials, and the like. Alternatively, the content may be internet service. In some embodiments, the content may be tactile content, like vibrations or force feedback, while in other embodiments, the content may be perceived with the nose, such as smells, scents, and the like.

In a further embodiment of method 300, controlling the content based on how the identity of the at least one person comprises any or all of the following: pausing the content when the identity of the at least one person capable of perceiving the content does not correspond to an identity of a person authorized to perceive the content, playing the content when the number identity of the at least one person capable of perceiving the content corresponds to an identity of a person authorized to perceive the content, and ceasing to play the content when the identity of the at least one person capable of perceiving the content does not correspond to an identity of a person authorized to perceive the content.

In a further embodiment, method 300 comprises any or all of the following steps: allowing at least one user to register for at least one broadcast of at least one program, using at least one image recording means to capture at least one image of the at least one user, and using at least one processor to analyze the image and determine how many users and/or the identity of the users that are in the image, and begin, continue, or cease broadcasting or playing the program based on how many users and/or the identity of the users that are determined to be in the image. In some embodiments, method 300 further comprises using at least one processor to begin broadcasting the program if the identity of the at least one person capable of perceiving the program corresponds to an identity of a person authorized to perceive the program.

In some embodiments, method 300 further comprises using at least one processor to continue broadcasting the program if the identity of the at least one person capable of perceiving the program does corresponds to an identity of a person authorized to perceive the program.

In some embodiments, method 300 further comprises using at least one processor to cease broadcasting the program if the identity of the at least one person capable of perceiving the content does not correspond to an identity of a person authorized to perceive the program.

The term program, as used throughout the present disclosure, may refer to any kind of program with any kind of content, such as, but not limited to, entertainment content, educational content, such as online courses, online exams, online classes, and the like.

In some embodiments, method 300 further comprises using at least one processor to carry out any of the aforementioned steps, or any other steps described in the present disclosure.

In some embodiments, method 300 may be implemented as a computer readable medium having computer executable instructions. The term “computer readable medium,” as used throughout this disclosure, may refer to any computer readable medium, such as CD-ROMs, CD-Rs, CD-RWs, floppy disks, hard drives, flash drives, diskettes, solid state drives, tape drives, and any other form of computer readable medium.

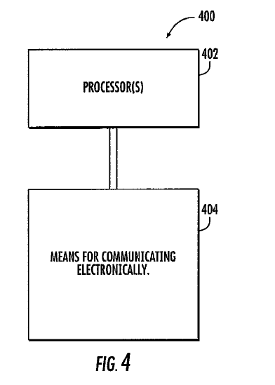

In some embodiments method 300 may be integrated wholly, or in part, into systems 100 and 200 described above, as well as other systems and methods described throughout the present disclosure. In some embodiments, method 300 may be carried out using the various systems described throughout the present disclosure. FIG. 4 shows a system 400, in accordance with one embodiment, wherein system 400 comprises at least one processor 402, at least one means 404 for communicating electronically, wherein means 404 for communicating electronically is electronically connected to at least one processor 402, and computer executable instructions (not shown) readable by at least one processor 402 and operative use at least one means 404 for communicating electronically to receive identity related information of a person from a remote terminal, and control content being transmitted to the remote terminal based on the identity related information.

In some embodiments, at least one processor 402 may be any kind of processor, including, but not limited to, a single core processor, a multi core processor, a video processor, and the like.

In some embodiments at least one means 404 for communicating electronically may be any kind of means, such as, but not limited to, a wireless modem, such as a GSM modem, a wired modern, an Ethernet adapter, a Wi-Fi adapter, and the like.

In other embodiments, content may be audio content, such as music, dialogue, and the like, and/or visual content, such as images, text, movies, television shows, sports events, educational content, such as courses, classes, exams, course materials, such as, but not limited to, online courses, online classes, online exams, online tutoring sessions, online materials, and the like.

In other embodiments, the identity related information may be a type of information selected from the group consisting essentially of an identity, an image, biometric information, an image of a face, an image of an eye, a fingerprint, an iris scan, an audio recording, such as a voice recording, and a 3D image. In some embodiments, the identity related information may be collected from a person at the remote terminal through at least one sensor, such as a camera, a fingerprint scanner, an eye tracker, an eye scanner, an iris scanner, and the like. In embodiments where the identity related information includes an identity, the identity determination may be made at the remote terminal and then communicated to system 400. In other embodiments, the identity determination may take place locally, such as in system 400, after having received identity related information, and determining an identity based on the identity related information.

Accordingly, in some embodiments, the computer executable instructions may be further operative to determine an identity of a person based on the identity related information. Such a determination may include biometric analysis, such as facial recognition analysis, iris recognition analysis, voice recognition analysis, and the like.

In yet a further embodiment, the computer executable instructions may be operative to compare the identity of the person with identities contained in a database. In some embodiments, the database may be stored on a storage module in electronic communication with at least one processor 402. The identities contained in the database may be the identities of those persons that have authorization to perceive the content, such as those persons that are authorized to take an exam or participate in a class. In other embodiments, the identities contained in the database may be the identities of those persons that do not have authorization to perceive the content, such as those persons that are not authorized to take an exam or participate in a class. In some embodiments, comparing the identity of the person with identities contained in a database includes comparing biometric information of the person collected at the remote terminal with biometric information stored on the database. Such biometric information may include any of those types of biometric information described throughout the present disclosure, such as, but not limited to, images, facial information, fingerprint information, images of faces, iris information, voice information, and the like.

In various embodiments, the remote terminal may be any kind of remote terminal, such as a kiosk, a computer, including, but not limited to, a personal computer, a notebook computer, a tablet computer, a mobile computer, a smart phone, and the like.

In some embodiments, the computer executable instructions may be further operative to control the content being transmitted to the remote terminal if the identity of the person corresponds to an identity contained in a database. In other embodiments, the computer executable instructions may be further operative to control the content being transmitted to the remote terminal if the identity of the person does not correspond to an identity contained in a database.

In some embodiments, controlling the content may comprise any or all of the following, pausing the content, playing the content, and/or ceasing to play the content. In a further embodiment, controlling the content comprises any or all of the following: pausing the content when the identity of the person does not correspond to an identity contained in a database; playing the content when the identity of the person corresponds to an identity contained in a database; and ceasing to play the content when the identity of the person does not correspond to an identity contained in a database. In other embodiments, controlling the content may include denying access to the content or granting access to the content.

In some embodiments, the identity of the person may be the identity of a person attempting to access online course material, such as, but not limited to, an online class, an online exam, or online material, while the content may be the online class, the online exam, or the online material. Accordingly, in some embodiments, if the identity of the person attempting to access the online course materials does not correspond to an identity contained in a database, such as an identity contained in a database of identities of persons authorized to access the online course materials, the computer executable instructions may be operative to deny that person access to the online course materials, such as by denying access to an online exam or class. In other embodiments, if the identity of the person attempting to access the online course materials corresponds to an identity in a database, such as an identity contained in a database of identities of persons authorized to access the online course materials, the computer executable instructions may be operative to grant that person access to the online course materials, such as by granting access to an online exam or class.

In alternate embodiments, if the identity of the person attempting to access the online course materials does not correspond to an identity contained in a database, such as an identity contained in a database of identities of persons not authorized to access the online course materials, the computer executable instructions may be operative to grant that person access to the online course materials, such as by granting access to an online exam or class. In other embodiments, if the identity of the person attempting to access the online course materials corresponds to an identity in a database, such as an identity contained in a database of identities of persons not authorized to access the online course materials, the computer executable instructions may be operative to deny that person access to the online course materials, such as by denying access to an online exam or class.

In yet further embodiments, the computer executable instructions maybe operative to store the identity related information in a database stored in a storage module in electronic communication with the at least one processor. The database may include a database of identity related information of persons authorized to access the content, or the database may include a database of identity related information of persons not authorized to access the content. In some embodiments, the identity related information may be collected during a registration process, as described below. In some embodiments, the identity related information may be stored in a database to be used at a later time to confirm that a person's identity, and consequently, a person, is authorized to access content.

In yet a further embodiment, the computer executable instructions may be operative to use at least one means 404 for communicating electronically to receive registration information from the remote terminal. The registration information may include identity related information, such as, but not limited to, a person's name, address, telephone number, e-mail address, student I.D., date of birth, social security number, and biometric information, such as, but not limited to, face information, such as a facial image, fingerprint information, iris information, voice information, such as a voice recording, and the like. In some embodiments, the registration may be a registration for content, such as online course content, such as, but not limited to, online classes, online exams, and the like.

In some embodiments, system 400 may be embodied be entirely or partially integrated into or with a computer, such as a personal computer, a notebook computer, a server computer, and the like.

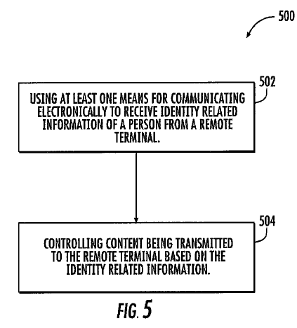

Referring now to FIG. 5, a blog diagram representing a method 500 is shown in accordance with one embodiment, wherein method 500 comprises using at least one processor to perform any or all of the following: using at least one means for communicating electronically to receive identity related information of a person from a remote terminal, and controlling content being transmitted to the remote terminal based on the identity related information.

In some embodiments, the at least one processor may be any kind of processor, including, but not limited to, a single core processor, a multi core processor, a video processor, and the like.

In some embodiments the at least one means for communicating electronically may be any kind of means, such as, but not limited to, a wireless modem, such as a GSM modem, a wired modem, an Ethernet adapter, a Wi-Fi adapter, and the like.

In other embodiments, content may be audio content, such as music, dialogue, and the like, and/or visual content, such as images, text, movies, television shows, sports events, educational content, such as courses, classes, exams, course materials, such as, but not limited to, online courses, online classes, online exams, online tutoring sessions, reading material, online material, and the like.

In other embodiments, the identity related information may be a type of information selected from the group consisting essentially of an identity, an image, biometric information, an image of a face, an image of an eye, a fingerprint, an iris scan, an audio recording, such as a voice recording, and a 3D image. In some embodiments, the identity related information may be collected from a person at the remote terminal through at least one sensor, such as a camera, a fingerprint scanner, an eye tracker, an eye scanner, an iris scanner, and the like. In embodiments where the identity related information includes an identity, the identity determination may be made at the remote terminal and then received using the at least one means for communicating electronically. In other embodiments, the identity determination may take place locally, such as in the at least one processor, after having received identity related information, and determining an identity based on the identity related information.

Accordingly, in some embodiments, method 500 may further include using the at least one processor to determine an identity of a person based on the identity related information. Such a determination may include biometric analysis, such as facial recognition analysis, iris recognition analysis, voice recognition analysis, mid the like.

In yet a further embodiment, method 500 may further include using the at least one processor to compare the identity of the person with identities contained in a database. In some embodiments, the database may be stored on a storage module in electronic communication with the at least one processor. The identities contained in the database may be the identities of those persons that have authorization to perceive the content, such as those persons that are authorized to take an exam or participate in a class. In other embodiments, the identities contained in the database may be the identities of those persons that do not have authorization to perceive the content, such as those persons that are not authorized to take an exam or participate in a class. In some embodiments, comparing the identity of the person with identities contained in a database includes comparing biometric information of the person collected at the remote terminal with biometric information stored on the database. Such biometric information may include any of those types of biometric information described throughout the present disclosure, such as, but not limited to, images, facial information, fingerprint information, images of faces, iris information, voice information, and the like.

In various embodiments, the remote terminal may be any kind of remote terminal, such as a kiosk, a computer, including, but not limited to, a personal computer, a notebook computer, a tablet computer, a mobile computer, a smart phone, and the like.

In some embodiments, method 500 may further include using the at least one processor to control the content being transmitted to the remote terminal if the identity of the person corresponds to an identity contained in a database. In other embodiments, method 500 may further include using the at least one processor to control the content being transmitted to the remote terminal if the identity of the person does not correspond to an identity contained in a database.

In some embodiments, controlling the content may comprise any or all of the following, pausing the content, playing the content, and/or ceasing to play the content. In a further embodiment, controlling the content comprises any or all of the following: pausing the content when the identity of the person does not correspond to an identity contained in a database; playing the content when the identity of the person corresponds to an identity contained in a database; and ceasing to play the content when the identity of the person does not correspond to an identity contained in a database. In other embodiments, controlling the content may include denying access to the content or granting access to the content.

In some embodiments, the identity of the person may be the identity of a person attempting to access online course material, such as, but not limited to, an online class, an online exam, or online material, while the content may be the online class, the online exam, or the online material. Accordingly, in some embodiments, if the identity of the person attempting to access the online course materials does not correspond to an identity contained in a database, such as an identity contained in a database of identities of persons authorized to access the online course materials, the computer executable instructions may be operative to deny that person access to the online course materials, such as by denying access to an online exam or class. In other embodiments, if the identity of the person attempting to access the online course materials corresponds to an identity in a database, such as an identity contained in a database of identities of persons authorized to access the online course materials, the computer executable instructions may be operative to grant that person access to the online course materials, such as by granting access to an online exam or class.

In alternate embodiments, if the identity of the person attempting to access the online course materials does not correspond to an identity contained in a database, such as an identity contained in a database of identities of persons not authorized to access the online course materials, method 500 may further include using the at least one processor to grant that person access to the online course materials, such as by granting access to an online exam or class. In other embodiments, if the identity of the person attempting to access the online course materials corresponds to an identity in a database, such as an identity contained in a database of identities of persons not authorized to access the online course materials, method 500 may further include using the at least one processor to deny that person access to the online course materials, such as by denying access to an online exam or class.

In yet further embodiments, method 500 may further include using the at least one processor to store the identity related information in a database stored in a storage module in electronic communication with the at least one processor. The database may include a database of identity related information of persons authorized to access the content, or the database may include a database of identity related information of persons not authorized to access the content. In some embodiments, the identity related information may be collected during a registration process, as described below. In some embodiments, the identity related information may be stored in a database to be used at a later time to confirm that a person's identity, and consequently, a person, is authorized to access content.

In yet a further embodiment method 500 may further include using the at least one processor to use at least one means for communicating electronically to receive registration information from the remote terminal. The registration information may include identity related information, such as, but not limited to, a person's name, address, telephone number, e-mail address, student I.D., date of birth, social security number, and biometric information, such as, but not limited to, face information, such as a facial image, fingerprint information, iris information, voice information, such as a voice recording, and the like. In some embodiments, the registration may be a registration for content, such as online course content, such as, but not limited to, online classes, online exams, and the like.

In some embodiments, method 500 may be implemented as a computer readable medium having computer executable instructions. The term “computer readable medium,” as used throughout this disclosure, may refer to any computer readable medium, such as CD-ROMs, CD-Rs, CD-RWs, floppy disks, hard drives, flash drives, diskettes, solid state drives, tape drives, and any other form of computer readable medium.

In some embodiments method 500 may be integrated wholly, or in part, into systems 100, 200, and 400, and method 300 described above, as well as other systems and methods described throughout the present disclosure. In some embodiments, method 500 may be carried out using the various systems described throughout the present disclosure.

### Hardware and Operating Environment

This section provides an overview of example hardware and the operating environments in conjunction with which embodiments of the inventive subject matter can be implemented.

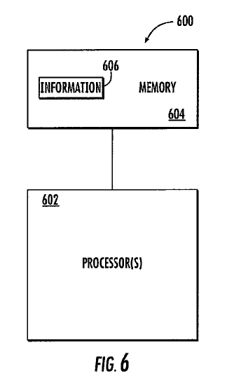

A software program may be launched from a computer readable medium in a computer-based system to execute function defined in the software program. Various programming languages may be employed to create software programs designed to implement and perform the methods disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed regarding FIG. 6 below.

FIG. 6 is a block diagram representing an article according to various embodiments. Such embodiments may comprise a computer, a memory system, a magnetic or optical disk, some other storage device, or any type of electronic device or system. The article 600 may include one or more processor(s) 602 coupled to a machine-accessible medium such as a memory 604 (e.g., a memory including electrical, optical, or electromagnetic elements). The medium may contain associated information 606 (e.g., computer program instructions, data, or both) which, when accessed, results in a machine (e.g., the processor(s) 602) performing the activities previously described herein.

The principles of the present disclosure may be applied to all types of computers, systems, and the like, include desktop computers, servers, notebook computers, personal digital assistants, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

1. A system comprising:
a. at least one processor;
b. at least one 3D sensor electronically connected to the at least one processor, and positioned at a location; and
c. computer executable instructions readable by the at least one processor and operative to:
i. use the at least one 3D sensor to determine a number of persons attempting to access an online class or online exam at the location;
ii. compare the number of persons attempting to access the online class or online exam at the location to a number of persons authorized to access the online class or online exam at the location; and
iii. if the number of persons attempting to access the online class or online exam at the location is less than or equal to the number of persons authorized to access the online class or online exam at the location, then allow at least one person to access the online class or online exam at the location.

2. The system of claim 1, further comprising at least one means for electronically connecting at least one broadcasting device to the system, wherein the at least one means for electronically connecting at least one broadcasting device is electronically connected to the at least one processor.

3. The system of claim 1, wherein the online class or online exam comprises an online class or online exam from a university.

4. The system of claim 1, wherein the computer executable instructions are further operative to control the online class or online exam based on the identity of at least one person attempting to access the online class or online exam.

5. The system of claim 1, wherein the computer executable instructions are further operative to control the online class or online exam if the identity of the at least one person attempting to access the online class or online exam does not correspond to an identity of at least one person authorized to access the online class or online exam.

6. The system of claim 4, wherein controlling the content includes any and/or all of the following: ceasing to display the content, pausing the content, displaying the content, or continuing to display the content.

7. The system of claim 1, further comprising at least one means for communicating with a local device, wherein the means for communicating with a local device is electronically connected to the at least one processor.

8. The system of claim 1, further comprising at least one means for communicating with a remote station, wherein the means for communicating is electronically connected to the at least one processor.

9. The system of claim 8, wherein the computer executable instructions are further operative to use the at least one means for communicating with a remote station to receive or transmit information from the remote station.

10. The system of claim 9, wherein the information is any or all of the following types of information: media content, a course, an online course or class, course materials, an online exam, educational materials, entertainment materials, the identity of the at least one person capable of perceiving the content, the identity of the person authorized to perceive the content, billing information, and software updates.

11. The system of claim 8, wherein the computer executable instructions are further operative to use the at least one means for communicating with a remote station to transmit identity related information captured by the at least one 3D sensor to a remote station.

12. The system of claim 1, wherein the computer executable instructions are further operative to allow the at least one person to use at least one user input means to register for or purchase authorization to access the online class or online exam.

13. A method comprising using at least one processor to perform any or all of the following:
a. using at least one sensor positioned at a location to determine a number of persons attempting to access an online class or online exam at the location;
b. comparing the number of persons attempting to access the online class or online exam at the location to a number of persons authorized to access the online class or online exam at the location;
if the number of persons attempting to access the online class or online exam at the location is less than or equal to the number of persons authorized to access the online class or online exam at the location, then allow at least one person to access the online class or online exam at the location
d.

14. The method of claim 13, wherein the at least one sensor is a type of sensor selected from the group consisting essentially of: a visual sensor, a 3D sensor, a 3D camera, an audio sensor, a tactile sensor, a thermal sensor, a chemical sensor, an electrical sensor, a capacitive sensor, a resistive sensor, a camera, a thermal imaging camera, a thumbprint scanner, an eye scanner, an iris scanner, a face scanner, and a microphone.

15. The method of claim 13, further comprising using at least one processor to receive the online class or online exam from a university or school.

16. The method of claim 13, further comprising controlling the online class or online exam based on an identity or number of one or more persons attempting to access the online class or online exam at the location, wherein controlling the online class or online exam comprises any or all of the following:
a. pausing the online class or online exam;
b. displaying the online class or online exam; and
c. ceasing to display the online class or online exam.

17. A non-transitory computer readable medium having computer executable instructions for performing a method comprising:
a. using at least one sensor positioned at a location to determine a number of persons attempting to access an online class or online exam at the location;
b. comparing the number of persons attempting to access the online class or online exam at the location to a number of persons authorized to access the online class or online exam at the location;
if the number of persons attempting to access the online class or online exam at the location is less than or equal to the number of persons authorized to access the online class or online exam at the location, then allow at least one person to access the online class or online exam at the location
d.

18. The non-transitory computer readable medium of claim 17, further comprising controlling the online class or online exam based on an identity or number of one or more persons attempting to access the online class or online exam at the location, wherein controlling the online class or online exam comprises any or all of the following:
a. pausing the online class or online exam;
b. displaying the online class or online exam; and
c. ceasing to display the online class or online exam.

19. A system comprising:
a. at least one processor;
b. at least one means for communicating electronically, wherein the means for communicating electronically is electronically connected to the at least one processor; and
c. computer executable instructions readable by the at least one processor, and operative to:
i. use the at least one means for communicating electronically to receive, from a remote terminal positioned at a remote location, a determination of a number of persons attempting to use the remote terminal to access an online class or online exam at the remote location, wherein the determination of the number of persons is determined by using at least one 3D sensor connected to the remote terminal and positioned at the remote location to determine a number of persons;
ii. compare the determination of the number of persons attempting to use the remote terminal to access the online class or online exam at the remote location to the number of persons authorized to access the online class or online exam at the remote location;
if the determination of the number of persons attempting to use the remote terminal to access the online class or online exam at the remote location is less than or equal to the number of persons authorized to access the online class or online exam at the remote location, then use the at least one means for communicating electronically to transmit the online class or online exam to the remote terminal
iv.

20. (canceled)

21. The system of claim 19, wherein the online class or online exam comprises an online class or online exam from a university or school.

22. The system of claim 19, wherein the computer executable instructions are operative to receive identity related information from the remote terminal.

23. The system of claim 22, wherein the computer executable instructions are further operative to determine an identity of a user based on the identity related information.

24. The system of claim 23, wherein the computer executable instructions are further operative to compare the identity of the user with identities of authorized persons contained in a database.

25. (canceled)

26. The system of claim 19, wherein the computer executable instructions are further operative to control the online class or online exam being transmitted to the remote terminal.

27. The system of claim 26, wherein controlling the online class or online exam comprises any or all of the following: pausing the online class or online exam, displaying the online class or online exam, and ceasing to display the online class or online exam.

28. The system of claim 23, wherein the computer executable instructions are operative to control the online class or online exam, wherein controlling the online class or online exam comprises any or all of the following:
a. pausing the online class or online exam when the identity of the user does not correspond to an identity of an authorized person;
b. displaying the online class or online exam when the identity of the user corresponds to an identity of an authorized person; and
c. ceasing to display the online class or online exam when the identity of the user does not correspond to an identity of an authorized person.

29. The system of claim 19, wherein the computer executable instructions are further operative to store the determination in a database stored on a storage module in electronic communication with the at least one processor.

30. The system of claim 19, wherein the computer executable instructions are further operative to use the at least one means for communicating electronically to receive registration or purchasing information from the remote terminal.

31. A method comprising using at least one processor to perform any or all of the following:
a. using at least one means for communicating electronically to receive, from a remote terminal positioned at a remote location, a determination of a number of persons attempting to use the remote terminal to access an online class or online exam at the remote location, wherein the determination of the number of persons is determined by using at least one 3D sensor connected to the remote terminal and positioned at the remote location to determine a number of persons;
b. comparing the determination of the number of persons attempting to use the remote terminal to access the online class or online exam at the remote location to the number of persons authorized to access the online class or online exam at the remote location;
if the determination of the number of persons attempting to use the remote terminal to access the online class or online exam at the remote location is less than or equal to the number of persons authorized to access the online class or online exam at the remote location, then using the at least one means for communicating electronically to transmit the online class or online exam to the remote terminal
d.

32. The method of claim 31, further comprising using the at least one processor to receive identity related information from the terminal.

33. The method of claim 31, wherein the online class or online exam comprises an online class or online exam from a university or school.

34. The method of claim 32, further comprising using at least one processor to determine an identity of a user based on the identity related information.

35. The method of claim 34, further comprising using at least one processor to compare the identity of the user with identities of authorized persons contained in a database.

36. The method of claim 31, further comprising using at least one processor to control the online class or online exam being transmitted to the remote terminal.

37. (canceled)

38. The method of claim 36, wherein controlling the online class or online exam comprises any or all of the following: pausing the online class or online exam, displaying the online class or online exam, and ceasing to display the online class or online exam.

39. The method of claim 34, further comprising using at least one processor to control the online class or online exam, wherein controlling the online class or online exam comprises any or all of the following:
a. pausing the online class or online exam when the identity of the user does not correspond to an identity of an authorized person;
b. displaying the online class or online exam when the identity of the user corresponds to an identity of an authorized person; and
c. ceasing to display the online class or online exam when the identity of the user does not correspond to an identity of an authorized person.

40. The method of claim 31, further comprising using at least one processor to store the determination in a database stored on a storage module in electronic communication with the at least one processor.

41. The method of claim 31, further comprising using at least one processor to use the at least one means for communicating electronically to receive a registration or purchasing information from the remote terminal.

42. A non-transitory computer readable medium containing computer executable instructions operative to:
a. use at least one means for communicating electronically to receive, from a remote terminal positioned at a remote location, a determination of a number of persons attempting to use the remote terminal to access an online class or online exam at the remote location, wherein the determination of the number of persons is determined by using at least one 3D sensor connected to the remote terminal and positioned at the remote location to determine a number of persons;
b. compare the determination of the number of persons attempting to use the remote terminal to access the online class or online exam at the remote location to the number of persons authorized to access the online class or online exam at the remote location;
if the determination of the number of persons attempting to use the remote terminal to access the online class or online exam at the remote location is less than or equal to the number of persons authorized to access the online class or online exam at the remote location, then use the at least one means for communicating electronically to transmit the online class or online exam to the terminal
d.
